(19) United States
(12) Patent Application Publication
(10) Pub. No.: US 2025/0272417 A1
(43) Pub. Date: Aug. 28, 2025

(54) Computing System Access Path Detection And Governance For Data Security Posture Management

(71) Applicant: Proofpoint, Inc., Suunyvale, CA (US)

(72) Inventors: Yang ZHANG, Fremont, CA (US); Ajay Agrawal, Bangalore (IN); Gautam KANAPARTHI, Los Altos, CA (US); Ravishankar Ganesh ITHAL, Los Altos, CA (US)

(73) Assignee: Proofpoint, Inc., Los Altos, CA (US)

(21) Appl. No.: 19/062,379

(22) Filed: Feb. 25, 2025

(30) Foreign Application Priority Data
Feb. 27, 2024 (IN) 202411014017

(51) Int. Cl. G06F 21/60; H04L 9/40; H04L 41/22

(52) U.S. Cl. CPC G06F 21/604; H04L 41/22; H04L 63/101; G06F 2221/2141

(57) ABSTRACT

A system for detection and organization of access paths in a computing environment includes a processor and memory accessible by the processor. The memory includes instructions executable to access permissions data and access control data for one or more computing resources in the computing environment, assemble a set of access paths to the one or more computing resources based on the permissions data and the access control data, trace the set of access paths to enumerate constituent elements along the access paths to the one or more computing resources, and automatically construct a unified access path graph representing the set of access paths. The unified access path graph includes node display elements connected by edge display elements to represent interdependencies between the constituent elements at one or more levels of granularity along the access paths to the one or more computing resources.

### CROSS-REFERENCE TO RELATED APPLICATION

The present application claims the benefit of Indian Application No. 202411014017, filed Feb. 27, 2024, the contents of which is hereby incorporated by reference in its entirety.

### FIELD OF THE TECHNOLOGY DISCLOSED

The technology disclosed generally relates to computing environments in which data is accessed through access paths. More specifically, but not by limitation, the present disclosure relates to improved systems and methods of data security and posture management (DSPM), cloud security posture management (CSPM), cloud infrastructure entitlement management (CIEM), cloud-native application protection platform (CNAPP), and/or cloud-native configuration management database (CMDB).

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Cloud computing provides on-demand availability of computer resources, such as data storage and compute resources, often without direct active management by users. Thus, a cloud environment can provide computation, software, data access, and storage services that do not require end-user knowledge of the physical location or configuration of the system that delivers the services. In various examples, remote servers can deliver the services over a wide area network, such as the Internet, using appropriate protocols, and those services can be accessed through a web browser or any other computing component.

Examples of cloud storage services include Amazon Web Services™ (AWS), Google Cloud Platform™ (GCP), and Microsoft Azure™, to name a few. Such cloud storage services provide on-demand network access to a shared pool of configurable resources. These resources can include networks, servers, storage, applications, services, etc. The end-users of such cloud services often include organizations that have a need to store sensitive and/or confidential data, such as personal information, financial information, and medical information. Such information can be accessed by any of a number of users through permissions and access control data assigned or otherwise defined through administrator accounts.

The discussion above is merely provided for general background information and is not intended to be used as an aid in determining the scope of the claimed subject matter.

### SUMMARY

The technology disclosure generally relates to data access path detection and governance for data security posture management. Using data scanners, for example, a system obtains permissions data and access control data for computing resources and analyzes the obtained data to identify a set of access paths. The access paths define users, roles, access privileges, and/or data store elements, and the access path details can be visualized in a single or unified access graph. The graph identifies how user access to particular data stores or other resources are set up, and identifies the type of sensitive data the users have access to. The privileges can be visualized at varying levels of granularity, such as, but not limited to, the data store, database, table and/or column levels. Further, the graph can visually identify interdependencies of users/roles/resources for remedial action.

In one example, a system for detection and organization of access paths in a computing environment includes a processor and memory accessible by the processor. The memory includes instructions executable to access permissions data and access control data for one or more computing resources in the computing environment, assemble a set of access paths to the one or more computing resources based on the permissions data and the access control data, trace the set of access paths to enumerate constituent elements along the access paths to the one or more computing resources, and automatically construct a unified access path graph representing the set of access paths. The unified access path graph includes node display elements connected by edge display elements to represent interdependencies between the constituent elements at one or more levels of granularity along the access paths to the one or more computing resources.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 is a block diagram illustrating one example of a cloud architecture.

FIG. 2 is a block diagram illustrating one example of a cloud service.

FIG. 3 is a block diagram illustrating one example of a cloud security posture analysis system.

FIG. 4 is a block diagram illustrating one example of a deployed scanner.

FIG. 5 is a flow diagram showing an example operation of on-boarding a cloud account and deploying one or more scanners.

FIG. 6 is a flow diagram illustrating one example of cloud infrastructure scanning performed by a cloud scanner deployed in a cloud service.

FIG. 7 is a flow diagram illustrating one example of scanning data stores in a cloud environment.

FIG. 8 is a flow diagram illustrating one example of generating access paths in a cloud environment and displaying an access graph that represents the access paths.

FIG. 9 illustrates an example user interface display.

FIG. 10 illustrates an example user interface display.

FIG. 11 illustrates an example user interface display.

FIG. 12 illustrates an example user interface display.

FIG. 13 illustrates an example user interface display.

FIG. 14 illustrates an example user interface display.

FIG. 15 illustrates an example user interface display.

FIG. 16 is a simplified block diagram of one example of a client device.

FIG. 17 shows an example computer system.

### DETAILED DESCRIPTION

The following discussion is presented to enable any person skilled in the art to make and use the technology disclosed, and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein.

As noted above, computing environments, such as cloud environments, are used by organizations or other users to store a wide variety of different types of information in many contexts and for many uses. This data can often include sensitive and/or confidential information, and can be the target for malicious activity such as acts of fraud, privacy breaches, data theft, etc. These risks can arise from individuals that are both inside the organization as well as outside the organization.

Cloud environments often include security infrastructure to enforce access control, data loss prevention, or other processes to secure data from potential vulnerabilities. However, even with such security infrastructures, it can be difficult for an organization to understand the data posture and breadth of access to the data stored in the cloud in the organization's cloud account. In other words, it can be difficult to identify which users have access to which data, and which data may be exposed to malicious or otherwise unauthorized users, both inside or outside the organization.

The present technology disclosed relates to data security posture management through data access path detection and governance. Using data scanners, for example, a system obtains permissions data and access control data for computing resources and analyzes the obtained data to identify a set of access paths. The access paths define users, roles, access privileges, and/or data store elements, and the access path details can be visualized in a single or unified access graph. The graph identifies how user access to particular data stores or other resources are set up, and identifies the type of sensitive data the users have access to. The privileges can be visualized at varying levels of granularity, such as, but not limited to, the data store, database, table and/or column levels. Further, the graph can visually identify interdependencies of users/roles/resources for remedial action.

It is noted that examples are discussed below in the context of public cloud environments and cloud storage. Further, at least some examples are described in the context of structured data stores. However, these examples are provided for the sake of illustration, and are not by limitation. Other types of computing environments and/or data stores, such as on premise data stores, data warehouses, etc., are within the scope of the present disclosure. The described graph visualization technology can be utilized beyond cloud storage, for example to visualize the full access path from user, role, privilege to database, table and the data classification for unstructured data and structured data stores in public clouds, on premise data stores, and/or data warehouses.

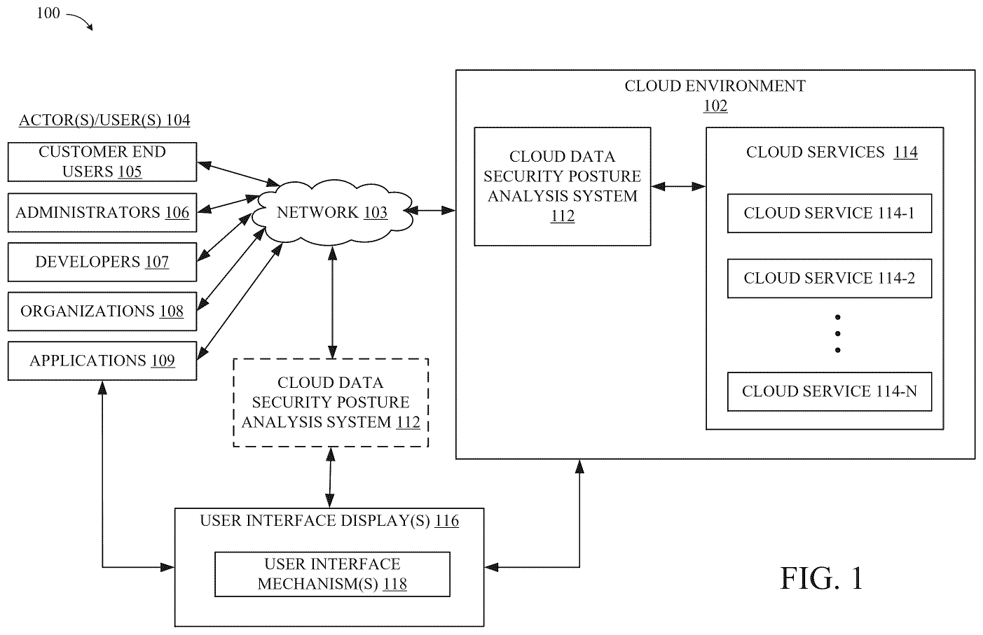

FIG. 1 is a block diagram illustrating one example of a cloud architecture 100 in which a cloud environment 102 is accessed by one or more actors 104, which can include endpoints and/or systems, through a network 103, such as the Internet or other wide area network. Cloud environment 102 includes one or more cloud services 114-1, 114-2, 114-N, collectively referred to as cloud services 114. As noted above, cloud services 114 can include cloud accounts and/or cloud storage services such as, but not limited to, AWS, GCP, Microsoft Azure, to name a few.

Further, cloud services 114-1, 114-2, 114-N can include the same type of cloud service, or can be different types of cloud services, and can be accessed by any of a number of different actors 104. For example, as illustrated in FIG. 1, actors 104 include users, which can include human users as well as non-human users, such as service accounts, system users, bots/automated users or other types of machine users. Examples of users include, but are not limited to, customer end users 105, administrators 106, developers 107, organizations 108, and/or applications 109. Of course, other users can access cloud environment 102 as well.

Cloud architecture 100 includes a cloud security posture analysis system 112 configured to access cloud services 114 to identify and analyze cloud security posture data. Examples of system 112 are discussed in further detail below. Briefly, however, system 112 is configured to access cloud services 114 and identify connected resources, entities, actors, etc. within those cloud services, and to identify risks and violations against access to sensitive information. As shown in FIG. 1, system 112 can reside within cloud environment 102 or outside cloud environment 102, as represented by the dashed box in FIG. 1. Of course, system 112 can be distributed across multiple items inside and/or outside cloud environment 102.

User(s) 104, can interact with cloud environment 102 through user interface displays 116 having user interface mechanisms 118. For example, a user can interact with user interface displays 116 provided on a user device (such as a mobile device, a laptop computer, a desktop computer, etc.) either directly or over network 103. Cloud environment 102 can include other items as well.

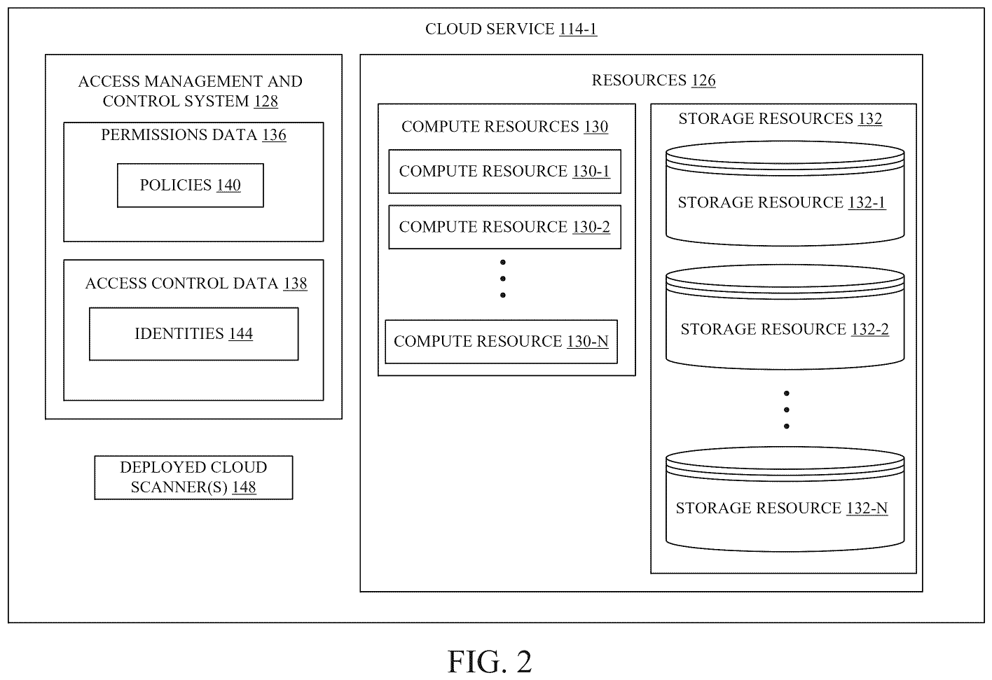

FIG. 2 is a block diagram illustrating one example of cloud service 114-1. For the sake of the present discussion, but not by limitation, cloud service 114-1 will be discussed in the context of an account within AWS. Of course, other types of cloud services and providers are within the scope of the present disclosure.

Cloud service 114-1 includes a plurality of resources 126 and an access management and control system 128 configured to manage and control access to resources 126 by actors 104. Resources 126 include compute resources 130, storage resources 132, and can include other resources. Compute resources 130 include a plurality of individual compute resources 130-1, 130-2, 130-N, which can be the same and/or different types of compute resources. In the present example, compute resources 130 can include elastic compute resources, such as elastic compute cloud (AWS EC2) resources, AWS Lambda, etc.

An elastic compute cloud (EC2) is a cloud computing service designed to provide virtual machines called instances, where users can select an instance with a desired amount of computing resources, such as the number and type of CPUs, memory and local storage. An EC2 resource allows users to create and run compute instances on AWS, and can use familiar operating systems like Linux, Windows, etc. Users can select an instance type based on the memory and computing requirements needed for the application or software to be run on the instance.

AWS Lambda is an event-based service that delivers short-term compute capabilities and is designed to run code without the need to deploy, use or manage virtual machine instances. An example implementation is used by an organization to address specific triggers or events, such as database updates, storage changes or custom events generated from other applications. Such a compute resource can include a server-less, event-driven compute service that allows a user to run code for many different types of applications or backend services without provisioning or managing servers.

Storage resources 132 are accessible through compute resources 130, and can include a plurality of storage resources 132-1, 132-2, 132-N, which can be the same and/or different types of storage resources. A storage resource 132 can be defined based on object storage which stores a plurality of data objects. For example, AWS Simple Storage Service (S3) provides highly-scalable cloud object storage with a simple web service interface. An S3 object can contain both data and metadata, and objects can reside in containers called buckets. Each bucket can be identified by a unique user-specified key or file name. A bucket can be a simple flat folder without a file system hierarchy. A bucket can be viewed as a container, such as a folder, for objects, such as files, stored in the S3 storage resource.

Compute resources 130 can access or otherwise interact with storage resources 132 through network communication paths based on permissions (or privileges) data 136 and/or access control data 138. In one example, system 128 includes identity and access management (IAM) functionality that controls access to cloud service 114-1 using entities, such as IAM entities, provided by the cloud computing platform.

Permissions data 136 includes policies 140. Permissions data 136 represents permissions, or privileges, that define what actions users or other actors can perform relative to certain cloud resources. The terms permissions or privileges will be used interchangeably in some examples described herein. Examples of permissions or privileges include, but are not limited to, open, read, write, and delete operations.

In one example, permissions data 136 encompasses a set of policies and rules that define the actions users or other actors can perform on specific cloud resources. This data includes identity-based policies, which are attached to IAM identities such as users, groups, or roles, granting specific permissions. Additionally, permissions data can include resource-based policies, which are directly attached to resources, such as S3 bucket policies or IAM role trust policies. These policies specify the allowed or denied actions, such as read, write, delete, or execute, and are expressed in a structured format, often using JSON. The permissions data is crucial for managing access control within the cloud environment, ensuring that only authorized entities can perform specific operations on the resources, thereby maintaining the security and integrity of the cloud infrastructure.

Access control data 138 includes identities 144 and associated attributes that define and manage access to cloud resources. Examples of identities 144 include, but are not limited to, various identity types, such as users, groups, and roles, each with specific permissions and access rights. In the context of AWS, for example, an IAM user is an entity created within the AWS service that represents a person or service interacting with the cloud service. IAM users are equipped with credentials, including a name, password, and access keys, to facilitate both interactive console access and programmatic requests via the API. Access control data also includes IAM groups, which are collections of IAM users with shared permissions, simplifying the management of access rights. Furthermore, IAM roles are defined within this data, representing identities with specific permissions that can be assumed by any authorized entity, allowing for flexible delegation of access across different users, applications, or services. This data is utilized for implementing robust access control mechanisms, ensuring that only authorized entities can access or modify cloud resources, thereby safeguarding the cloud environment against unauthorized access and potential security breaches.

In AWS, for example, an IAM user is an entity that is created in the AWS service and represents a person or service who uses the IAM user to interact with the cloud service. An IAM user provides the ability to sign into the AWS management console for interactive tasks and to make programmatic requests to AWS services using the API, and includes a name, password, and access keys to be used with the API. Permissions can be granted to the IAM user to make the IAM user a member of a user group with attached permission policies. An IAM user group is a collection of IAM users with specified permissions. Use of IAM groups can make management of permissions easier for those users. An IAM role in AWS is an IAM identity that has specific permissions, and has some similarities to an IAM user in that the IAM role is an AWS identity with permission policies that determine what the identity can and cannot do in AWS. However, instead of being uniquely associated with one person, a role is intended to be assumable by anyone who needs the role. Roles can be used to delegate access to users, applications, and/or services that don't normally have access to the AWS resources. Roles can be used by IAM users in a same AWS account and/or in different AWS accounts than the role. Also, roles can be used by compute resources 130, such as EC2 resources. A service role is a role assumed by a service to perform actions in an account on behalf of a user. Service roles include permissions required for the service to access the resources needed by the service. Service roles can vary from service to service. A service role for an EC2 instance, for example, is a special type of service role that an application running on an EC2 instance can assume to perform actions.

Policies 140 can include identity-based policies that are attached to IAM identities that can grant permissions to the identity. Policies 140 can also include resource-based policies that are attached to resources 126. Examples include S3 bucket policies and IAM role trust policies.

Cloud service 114-1 includes one or more deployed cloud scanners 148. Cloud scanner 148 runs locally on the cloud-based services and the server systems, and can utilize elastic compute resources, such as, but not limited to, AWS Lambda resources. Cloud scanner 148 is configured to access and scan the cloud service 114-1 on which the scanner is deployed. Examples are discussed in further detail below. Briefly, however, a scanner accesses the data stored in storage resources 132, permissions data 136, and access control data 138 to identify particular data patterns (such as, but not limited to, sensitive string patterns) and traverse or trace network communication paths between pairs of compute resources 130 and storage resources 132. The results of the scanner can be utilized to identify subject vulnerabilities, such as resources vulnerable to a breach attack, and to construct a cloud attack surface graph or other data structure that depicts propagation of a breach attack along the network communication paths.

Given a graph of connected resources, such as compute resources 130, storage resources 132, entities such as accounts, roles, policies, etc., and actors such as end users, administrators, etc., risks and violations against access to sensitive information are identified. A directional graph can be built to capture nodes that represent the resources and labels that are assigned for search and retrieval purposes. For example, a label can mark the node as a database or S3 resource, actors as end users, administrators, developers, etc. Relationships between the nodes are created using information available from the cloud infrastructure configuration. For example, using the configuration information, system 112 can determine that a resource belongs to a given account and create a relationship between the policy attached to a resource and/or identify the roles that can be taken up by a user.

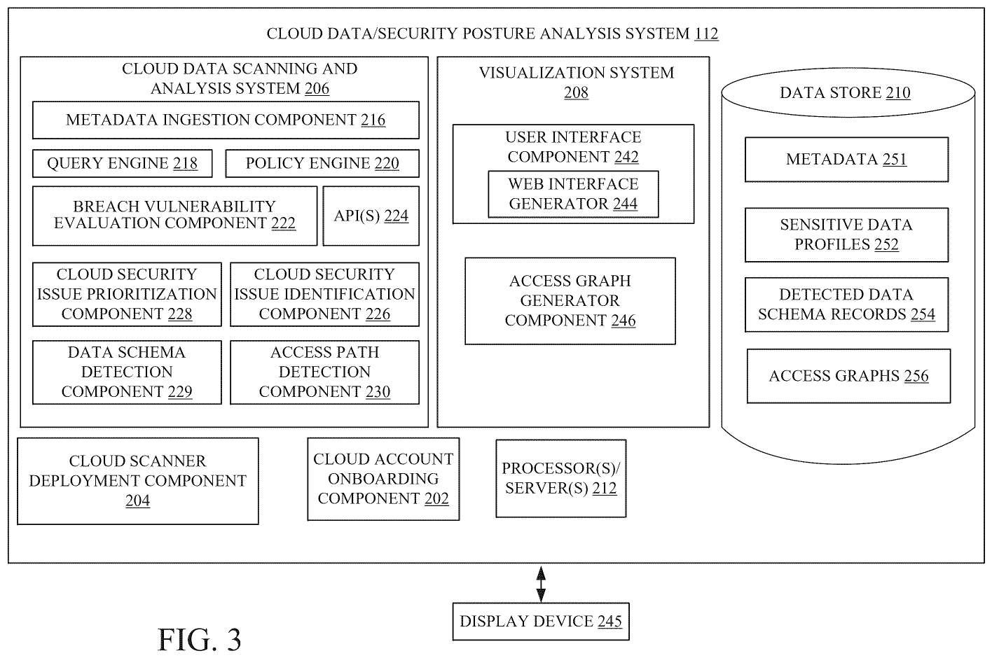

FIG. 3 is a block diagram illustrating one example of a cloud security posture analysis system 112. As noted above, system 112 can be deployed in cloud environment 102 and/or access cloud environment 102 through network 103 shown in FIG. 1.

System 112 includes a cloud account onboarding component 202, a cloud scanner deployment component 204, a cloud data scanning and analysis system 206, a visualization system 208, and a data store 210. System 112 can also include one or more processors or servers 212.

Cloud account onboarding component 202 is configured to onboard cloud services 114 for analysis by system 112. After onboarding, cloud scanner deployment component 204 is configured to deploy a cloud scanner, such as deployed cloud scanner(s) 148 shown in FIG. 2) to the cloud service. In one example, the deployed scanners are on-demand agent-less scanners configured to perform agent-less scanning within the cloud service. One example of an agent-less scanner does not require agents to be installed on each specific device or machine. The scanners operate on resources 126 and access management and control system 128 directly within the cloud service, and generate metadata that is returned to system 112. Thus, in one example, the actual cloud service data is not required to leave the cloud service for analysis.

Cloud data scanning and analysis system 206 includes a metadata ingestion component 216 configured to receive the metadata generated by the deployed cloud scanner(s) 148. System 206 also includes a query engine 218, a policy engine 220, a breach vulnerability evaluation component 222, one or more application programming interfaces (APIs) 224, a cloud security issue identification component 226, a cloud security issue prioritization component 228, a data schema detection component 229, and an access path detection component 230.

Query engine 218 is configured to execute queries against the received metadata and generated cloud security issue data. Policy engine 220 can execute security policies against the cloud data and the breach vulnerability evaluation component 222 is configured to evaluate potential breach vulnerabilities in the cloud service. APIs 224 are exposed to users, such as administrators, to interact with system 112 to access the cloud security posture data. Component 226 is configured to identify cloud security issues and component 228 can prioritize the identified cloud security issues based on any of a number of criteria.

Access path detection component 230 is configured to detect user access paths to data in resources 126 based on the metadata. An example user access path is defined as an ordered set of constituent elements, and can be stored as a tuple or other data structure. For instance, an example access path includes a user having a particular role that uses a privilege (or permission) to access a portion of a structured database, and can be defined as
access path=(user, role, privilege, resource)

Further, the user access path can identify the entities and/or classification tags in the resource, such as tables, columns, or other portions of the structured database.

Visualization system 208 is configured to generate visualizations of the cloud security posture from system 206. Illustratively, system 208 includes a user interface component 242 configured to generate a user interface for a user, such as an administrator. In the illustrated example, component 242 includes a web interface generator 244 configured to generate web interfaces that can be displayed on a display device 245 in a web browser on a client device. Visualization system 208 also includes an access graph generator component 246. Access graph generator component 246 is configured to generate an access graph 256 representing the access paths detected by component 230.

Data store 210 stores metadata 251 obtained by metadata ingestion component 216, sensitive data profiles 252, detected data schema records 254, access graphs 256. Examples of sensitive data profiles 252 are discussed in further detail below. Briefly, however, sensitive data profiles 252 can identify target data patterns that are to be categorized as sensitive or conforming to a predefined pattern of interest. Sensitive data profiles 252 can be used as training data for data classification performed by data schema detection component 229. Pattern matching can be performed based on the target data profiles. Illustratively, pattern matching can be performed to identify instances of data patterns corresponding to social security numbers, credit card numbers, other personal data, medical information, to name a few. In one example, artificial intelligence (AI) is utilized to perform named entity recognition, such as natural language processing modules, can identify sensitive data, in various languages, representing names, company names, locations, etc.

Detected data schema records 254 store detected instances of the target data profiles or entities that are returned based on content-based classification of the cloud data. An example detected data schema record 254 can store any of a variety of different data items representing the detected instance corresponding to the data record, including, but not limited to, a data store identifier, a database identifier, a table name identifier, a column name identifier, a column type identifier, a target data entity identifier, and/or a confidence score, among other data. A data store identifier identifies a particular data store that contains the detected instance of the target data profiles. A database identifier identifies a particular database, in the particular data store, that contains the detected instance of the target data profiles. A table name identifier identifies a particular table, in the particular database, that contains the detected instance of the target data profiles. A column name identifier identifies the column name associated with a particular column that contains the detected instance of the target data profiles. A column type identifier identifies a data type, such as a date, integer, timestamp, character string, or decimal. A target data entity identifier identifies the target data profile that was matched in the detected instance. A confidence score identifies a confidence associated with the classification.

Access graphs 256 represent user access paths that are identified based on permissions data and access control data for cloud resources. The access graphs can be stored in any of a variety of formats including, but not limited to, a graph database such as the neo4j graph database management system.

A graph database stores a graph database definition and/or other metadata that defines and represents a data model. Nodes have relationships defined by edges, which can connect a given node to one or more other nodes. A node is a unit in the graph that typically represents one or more constituent elements from the access paths. For example, a node can be a group node representing a group of constituent elements, such as two or more of the users, roles, privileges, etc. in the access paths. Also, using drill down or expand functionality, a group node can be broken down into individual nodes, each representing a single constituent element, such as a single user, a single role, a single privilege, etc. in the access path. The relationships between nodes can be directed or undirected. Properties, such as key/value pairs, can be assigned to a node or a relationship.

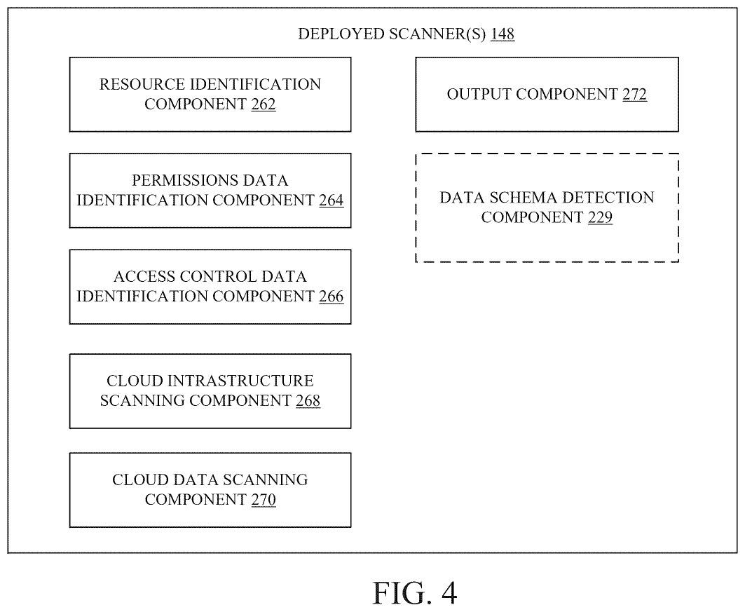

FIG. 4 is a block diagram illustrating one example of a deployed scanner 148. Scanner 148 can be deployed locally in the cloud environment using an elastic compute resource, such as an AWS lambda instance, in the cloud environment. Scanner 148 includes a resource identification component 262, a permissions data identification component 264, an access control data identification component 266, a cloud infrastructure scanning component 268, a cloud data scanning component 270, an output component 272, and can include other items as well. FIG. 4 also illustrates that some or all components of and/or functionality performed by data schema detection component 229 can be on or otherwise associated with deployed scanner 148.

Resource identification component 262 is configured to identify the resources 126 within cloud service 114-1 (and/or other cloud services 114) and to generate corresponding metadata that identifies these resources. Permissions data identification component 264 identifies the permissions data 136; the access control data identification component 266 identifies access control data 138. Cloud infrastructure scanning component 268 scans the infrastructure of cloud service 114 to identify the relationships between resources 130 and 132. Cloud data scanning component 270 scans the actual data stored in storage resources 132. Output component 272 is configured to output the generated metadata and content-based classification results to cloud security posture analysis system 112.

The metadata generated by scanner 148 can indicate a structure of schema objects in a data store. For example, where the schema objects comprise columns in a data store having a tabular format, the returned metadata can include column names from those columns. A content-based data item classifier is configured to classify data items within the schema objects, based on content of those data items.

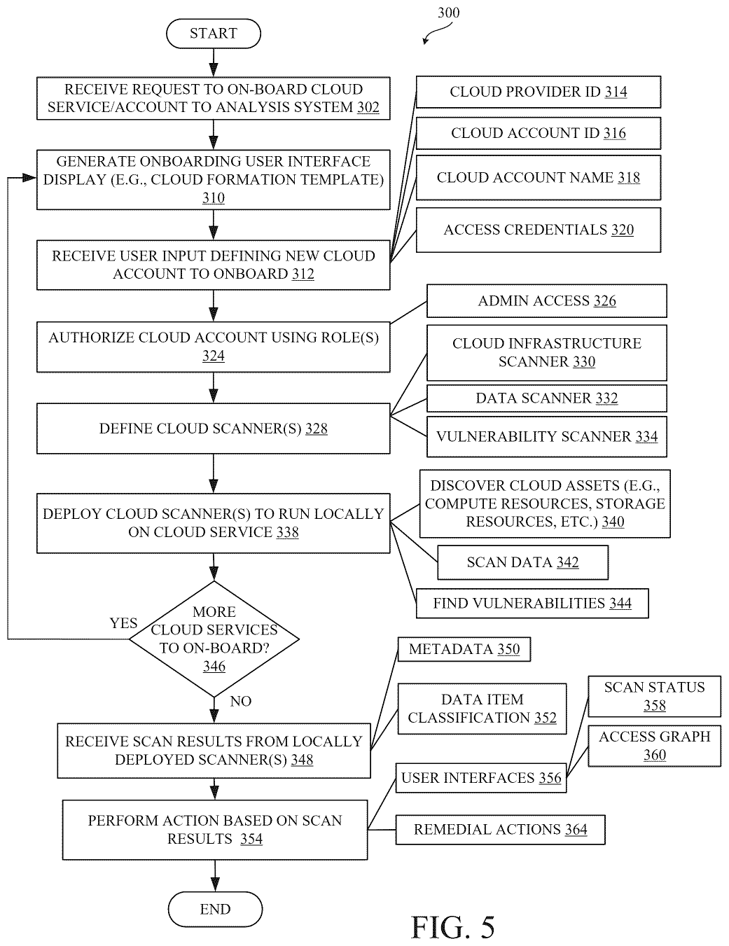

FIG. 5 is a flow diagram 300 showing an example operation of system 112 for on-boarding a cloud account and deploying one or more scanners. At block 302, a request to on-board a cloud service to cloud security posture analysis system 112 is received. For example, an administrator can submit a request to on-board cloud service 114-1.

At block 310, an on-boarding user interface display is generated. At block 312, user input is received that defines a new cloud account to be on-boarded. The user input can define a cloud provider identification 314, a cloud account identification 316, a cloud account name 318, access credentials to the cloud account 320, and can include other input defining the cloud account to be on-boarded.

At block 324, the cloud account is authorized using roles. For example, administrator access (block 326) can be defined for the cloud scanner using IAM roles. One or more cloud scanners are defined at block 328 and can include, but are not limited to, cloud infrastructure scanners 330, cloud data scanners 332, vulnerability scanners 334, or other scanners.

At block 338, the cloud scanners are deployed to run locally on the cloud service, such as illustrated in FIG. 2. The cloud scanners discover cloud assets at block 340. The cloud assets can include, but are not limited to, compute resources (such as elastic compute resources), storage resources, or other types of resources. At block 342, the data is scanned.

At block 344, vulnerabilities are identified based on finding a predefined risk signature in the cloud service resources. The risk signatures can be queried upon, and can define expected behavior within the cloud service and locate anomalies based on this data.

At block 346, if more cloud services are to be on-boarded, operation returns to block 310. At block 348, the scan results from the deployed scanners are received. As noted above, the scan results include metadata (block 350) and/or data item classifications (block 352) generated by the scanners running on the cloud service.

At block 354, one or more actions are performed based on the scan results. For example, the action can include providing user interfaces at block 356 that indicate the scan status (block 358), an access graph (block 360), and/or other representations. Remedial actions can be taken at block 364. For example, the system can make adjustments to cloud account settings/configurations to address/remedy detected security issues. Of course, other actions can also be taken.

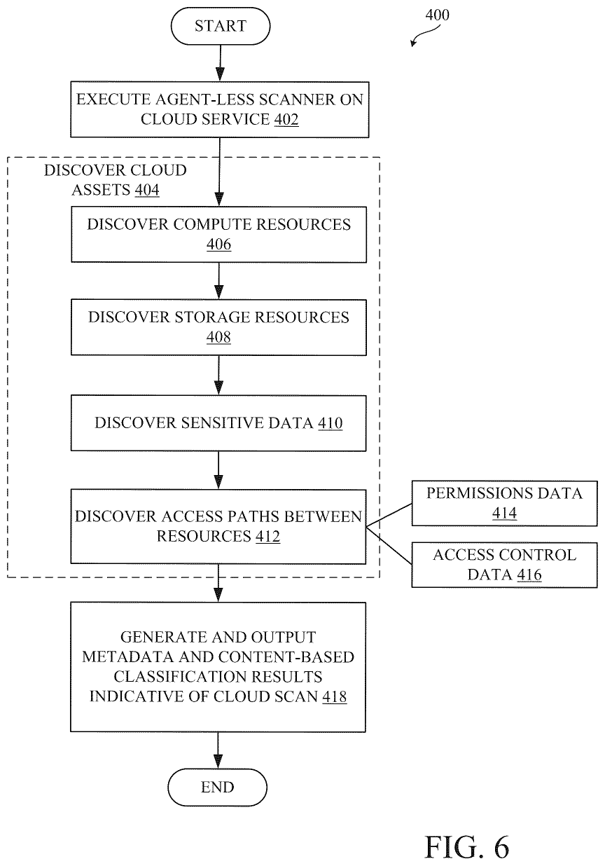

FIG. 6 is a flow diagram 400 illustrating one example of cloud infrastructure scanning performed by cloud scanner 148 deployed in cloud service 114-1. At block 402, an agent-less scanner is executed on the cloud service. At block 404, the scanner discovers cloud assets based on execution of the scanner. Block 404 can include, at block 406, the scanner discovering the compute resources 130 and, at block 408, the storage resources 132. Sensitive data can be discovered at block 410. The agent-less scanner does not require a proxy or agent running in the cloud service, and can utilize server-less containers and resources to scan the documents and detect sensitive data. The data can be accessed using APIs associated with the scanners. The sensitive data can be identified using pattern matching, such as by querying the data using predefined risk signatures.

At block 412, access paths between the resources are discovered based on permissions data 136 (block 414), and/or access control data 138 (block 416). A rule processing engine, such as using JSON metadata, can be utilized to analyze the roles and policies, and can build access relationships between the nodes representing the resources. The policies can be decoded to get access type (allow, deny, etc.) and the policy can be placed in a node to link from a source to target node and create the access relationship. At block 418, metadata and/or content-based classification results indicative of the scanning are generated and outputted by output component 272.

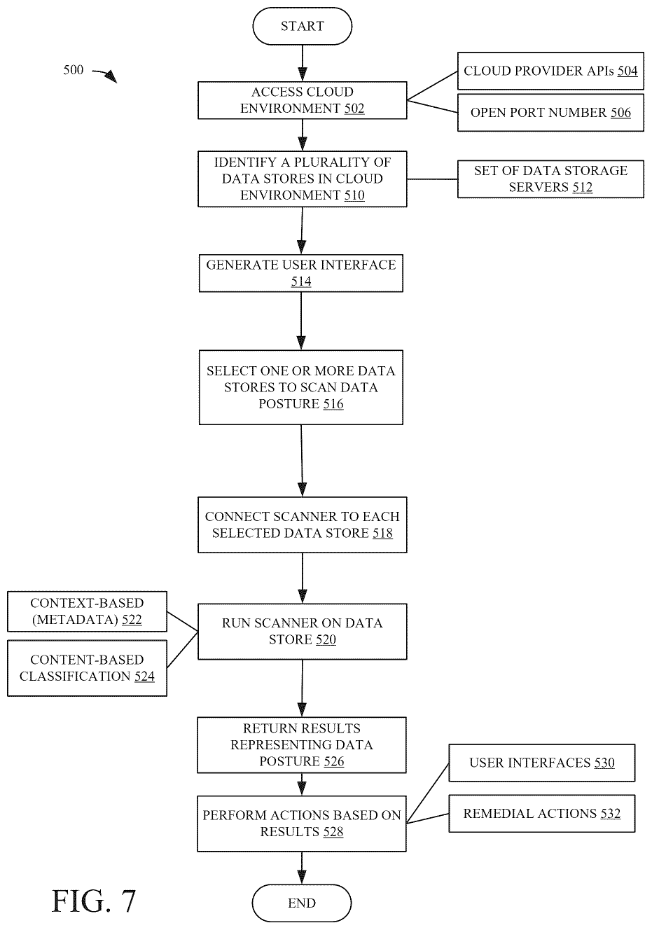

FIG. 7 is a flow diagram 500 illustrating one example of scanning data stores in a cloud environment. For sake of illustration, but not by limitation, FIG. 7 will be discussed in the context of cloud security posture analysis system 112.

At block 502, system 112 accesses a cloud account in a cloud environment onboarded by cloud account onboarding component 202. Onboarding can be done in any of a number of ways. For example, the cloud environment can be accessed through a cloud provider application programming interface (API) at block 504. The cloud environment can also be accessed using open port numbers at block 506.

At block 510, a plurality of data stores is identified in the cloud environment. In one example, the plurality of data stores includes a set of data storage servers. Thus, each data store can include a server having one or more databases logically defined thereon, as represented at block 512. At block 514, a user interface display is generated that displays the identified data stores.

At block 516, one or more data stores are selected to scan. At block 518, one or more scanners are connected to each selected data store. At block 520, the scanner is run on the data store to perform context-based classification (block 522) and content-based classification (block 524).

At block 526, results are returned representing the data posture. One or more actions are performed based on the results at block 528. For example, one or more user interfaces can be generated at block 530 providing the results of the scan, as well as providing user input mechanisms for a user to interact with the results, such as to drill up or drill down in the results, perform remedial actions, etc. Remedial actions are illustrated at block 532.

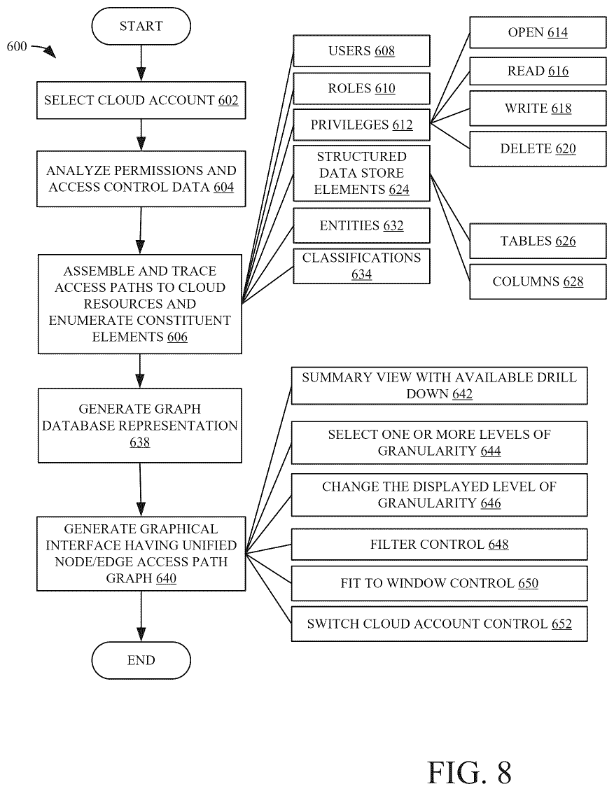

FIG. 8 is a flow diagram 600 illustrating one example of detecting and organizing access paths in a cloud environment and generating and displaying an access graph that represents the access paths.

At block 602, a cloud account is selected. For instance, an administrator of an organization may have a plurality of different cloud accounts that the administrator manages and desires to analyze. At block 604, permissions and access control data are analyzed. Permissions can include privileges that define which types of actions can be taken, and access control data can include roles associated with various users.

Block 606 assembles and traces access paths to cloud resources based on the permissions and access control data. Access paths define how various users, such as customer end users, applications, or services, access or otherwise interact with data stores or other resources, and can include direct access, access through a role, or complex hierarchical access involving multiple roles and/or policies.

Tracing access paths can involve a detailed analysis of permissions data and access control data to map out the routes through which users, roles, and/or privileges interact with data resources. This process can examine the permissions data to identify the specific actions that users and/or roles are allowed to perform on various resources. The system then correlates this information with access control data, which can include, for example, identities and roles associated with each user, to determine a hierarchical structure of access. Alternatively, or in addition, event logs that capture activity within the cloud environment can be accessed and analyzed to identify access path information.

In one example, block 606 enumerates all users within the subject cloud environment being analyzed, and then identifies all roles that have been assigned to those users. From the access control and/or permissions data, privileges of the roles are identified. Then, the data resources, such as database tables and columns within those tables, to which the privileges grant access are determined. Entities within the data resources, and classifications of those entities, are identified.

Block 606 enumerates constituent elements along the access paths, such as users 608, roles 610, and/or privileges 612, and maps these elements to the corresponding data resources, including databases, tables, and columns. In one example, the mapping is achieved by analyzing the relationships and dependencies defined in the permissions data, access control data, and/or event log information, which specify how roles are linked to privileges and how these privileges grant access to specific data resources. Privileges 612 can include permissions to open 614 a data resource, read 616 data in a data resource, write 618 data to a data resource, and delete 620 data from a data resource.

The elements in the access paths can also include structured data store elements 624, that identifies constituent portions of a structured data store. Examples include, but are not limited to, tables 626, columns 628 within a table, and/or other items.

The elements can also include entities 632 and classifications 634. Entities 632 may include instances of data that match one or more pre-defined entity profiles, such as a predefined data pattern. Particular examples include credit card numbers, social security numbers, telephone numbers, email addresses, etc. Further, examples of classifications 634 include financial data, payment card industry (PCI) data, and personally identifiable information (PII).

In one example, the access paths traced at block 606 can include access paths to different types of data stores. Illustratively, a data store includes a system used to collect, manage, and store data for various use cases, such as analytics, transactions, or real-time processing. Different types of data stores are optimized for different data structures, access patterns, and performance requirements. Examples of different types of data stores include, but are not limited to, relational databases (RDBMS), noSQL databases, data warehouses optimized for analytical processing (OLAP), data lakes, object stores, file storage, block storage, and graph databases.

The constituent elements of the access paths are constructed into groups, where each group can represent a plurality of elements or members, as well as a singular element or member. For instance, if ten different users are identified along the set of access paths, a user group element is created to collectively represent the ten users.

At block 638 a graph database representation is generated to represent the user access paths identified at block 606. In one example, a unified access path graph is constructed to represent the set of access paths, and includes node display elements connected by edge elements to represent interdependencies between the constituent elements, or element groups, along the access paths to the one or more computing resources. The graph provides a granular view of access paths, enabling organizations to identify potential security risks and ensure compliance with data governance policies.

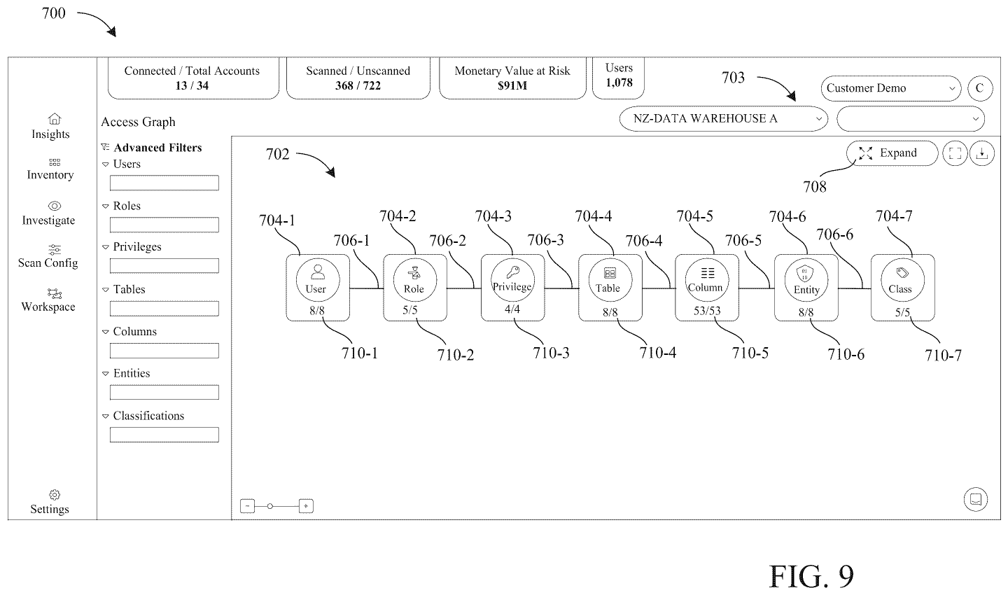

At block 640, an interactive graphical interface is generated with the unified access path graph. The graphical interface can provide a single view of the user access paths and is interactive such that a user can navigate through the access paths to view the information at various selectable levels of granularity. Examples of user interfaces are discussed below with respect to FIGS. 9-15.

The graphical interface can include a summary view, represented at block 642. In one example, the summary view represents the access paths at the group level, with nodes collectively representing the constituent element groups and edges collectively representing the relationships between any of the constituent elements represented by the respective pairs of nodes. The summary view can also include actuatable drill down and/or actuatable drill up buttons (when available) to present additional information and/or views at different levels of granularity. At block 644, one or more levels of granularity are selected and, at block 646, the graphical interface is modified to change the access path graph to represent the access paths at the one or more levels of granularity. For example, the graphical interface can be switched between expanded and collapsed views.

The graphical interface can include a filter control 648 configured to receive one or more filter criterion inputs that define filter criterion to filter the access graph, a fit to window control 650, a switch cloud account control 652, and/or other controls as well.

In one example, the access graph provides a comprehensive visualization of access paths across multiple different types of data stores within a single organization or team. This capability can be particularly useful for organizations which utilize diverse data warehouse platforms. The ability to consolidate access paths from different data store types into a single graph can be useful for an organization that relies on multiple data platforms to meet diverse data processing and storage needs. For instance, while one platform might be used for its robust data warehousing capabilities, another platform could be employed for its advanced analytics and machine learning features. The unified access graph not only illustrates the direct access paths from users to data elements but also highlights the interdependencies and potential security risks associated with these paths. By visualizing these access paths in a single graph, organizations can more effectively manage permissions, identify vulnerabilities, and ensure compliance with data governance policies, ultimately enhancing their overall data security posture.

An internal user includes a trusted entity, such as an employee, system, or service, that belongs to the organization owning the cloud account and has direct access to cloud resources through the organization's Identity and Access Management (IAM) policies. These users are managed by the organization, operate within corporate security policies, and typically have long-term access using organization-provided credentials.

In some scenarios, an organization can utilize external or third party tools or other services. An example external third-party tool in relation to AWS includes a software, service, or platform developed and managed independently by a third party that integrates with AWS resources. These tools interact with AWS services through mechanisms such as APIs, SDKs, direct database connections, or networking integrations, and are not natively hosted within AWS. The tools can reside on external cloud providers like Google Cloud or Azure, or on-premises infrastructure, accessing AWS services via public endpoints, VPN, Direct Connect, or cross-cloud integrations.

In such cases, the access graph can represent elements of those services. For instance, assume for sake of illustration that an organization uses an external service to manage user access to resources in the organizations cloud accounts. The system can integrate with the external service to map external users of the external service to corresponding internal users of the organization's cloud accounts. This integration allows the access graph to incorporate access paths managed by third-party tools, providing a more comprehensive view of user interactions with data resources. By visualizing these integrated access paths, the organization gains a unified perspective on how external tools influence data access, enabling more effective monitoring and management of data security and governance.

An external user illustratively includes an untrusted or semi-trusted entity outside the organization that requires limited and controlled access to a cloud account, typically for collaboration, integration, or service usage. These external users do not belong to the organization's primary identity provider and usually have temporary or restricted access, necessitating mechanisms like cross-account trust, external identity federation, or guest access with limited permissions.

FIG. 9 illustrates one example of a graphical interface 700 including a unified access path graph 702 that represents the access path for a selected cloud account, or plurality of cloud accounts, selected through a cloud account input mechanism 703. For example, mechanism 703 can include a drop-down box having a plurality of selectable elements corresponding to cloud accounts associated with a given user.

Access path graph 702 includes a plurality of node elements 704-1, 704-2, 704-3, 704-4, 704-5, 704-6, and 704-7 (collectively referred to as node elements 704) and edge elements 706-1, 706-2, 706-3, 706-4, 706-5, and 706-6 (collectively referred to as edge elements 706). Each edge element 706 connects two or more node elements 704 and represents that there is at least one relationship in the access paths defined between elements represented by the respective pair of node elements 704.

Graphical interface 700 is configured to display the access path graph at a plurality of different levels of granularity, which are selectable through interface 700, to show more or less details of the access paths. For instance, at a first level of granularity, a summary view is provided in which node elements 704 are group elements (also referred to as group elements 704) that each represent a group of constituent elements from the access paths. Using an available drill down or expand control, the access path graph is modified to replace one or more of the group elements with a plurality of node elements that each represent individual constituent elements from the access paths. In this way, the drill down or expand control can break down a group node into individual nodes, each representing a single constituent element, such as a single user, a single role, a single privilege, etc. in the access path.

For example, user group element 704-1 collectively represents all users identified from the access paths and role group element 704-2 collectively represents all roles associated with any one of those users. Edge element 706-1 between group elements 704-1 and 704-2 indicates that at least one user represented by element 704-1 has at least one role represented by element 704-2. Privilege group element 704-3 collectively represents all privileges that have been assigned to any of the roles represented by the role group element 704-2.

Node elements 704 can also include at least one data store group element representing one or more data stores to which at least one privilege, represented by privilege group element 704-3, grants access. Illustratively, the data store group elements can include a table group element 704-4 and a column group element 704-5. Table group element 704-4 collectively represents all tables in the data store(s) to which at least one privilege, represented by privilege group element 704-3, grants access. Column group element 704-5 collectively represents all of the columns within those tables.

Node elements 704 also include an entity group element 704-6 collectively representing instances of data stored in the data stores that match at least one pre-defined data entity profile. For example, an entity profile can represent a pre-defined data pattern. A classification group element 704-7 represents one or more classification tags that are associated with the instances of data that match the entity profiles.

Graphical interface 700 includes an available drill down, illustratively in the form of control 708, that is actuatable to expand one or more node elements 704 and/or one or more edge elements 706 in the summary view, to represent the access paths at a second level of granularity by visualizing the individual elements in one or more of the groups. Control 708 can be a global control that expands any and all node elements representing a plurality of individual constituent elements. In another example, a number of separate expand controls can be provided on, or otherwise in association with, each node element 704, such that actuation of a particular expand control expands only the respective node element 704.

Each group element in the summary view can include a numerical counter 710-1, 710-2, 710-3, 710-4, 710-5, 710-6, and 710-7 (collectively referred to as numerical counters 710) that identifies the total number of constituent elements from all access paths that are represented by the respective node along with the number of those constituent elements that are included with any currently defined filter criterion. For example, numerical counter 710-1 indicates that there are eight total users in the cloud account, and all eight users are being represented by user group element 704-1 as no filter criterion has been presently defined. Upon input of a filter criterion, numerical counters 710 are modified based on the filter results. For instance, if an administrative role is provided as a role filter criterion, numerical counter 710-1 is updated to identify how many users, represented by user group element 704-1 are assigned the administrative role.

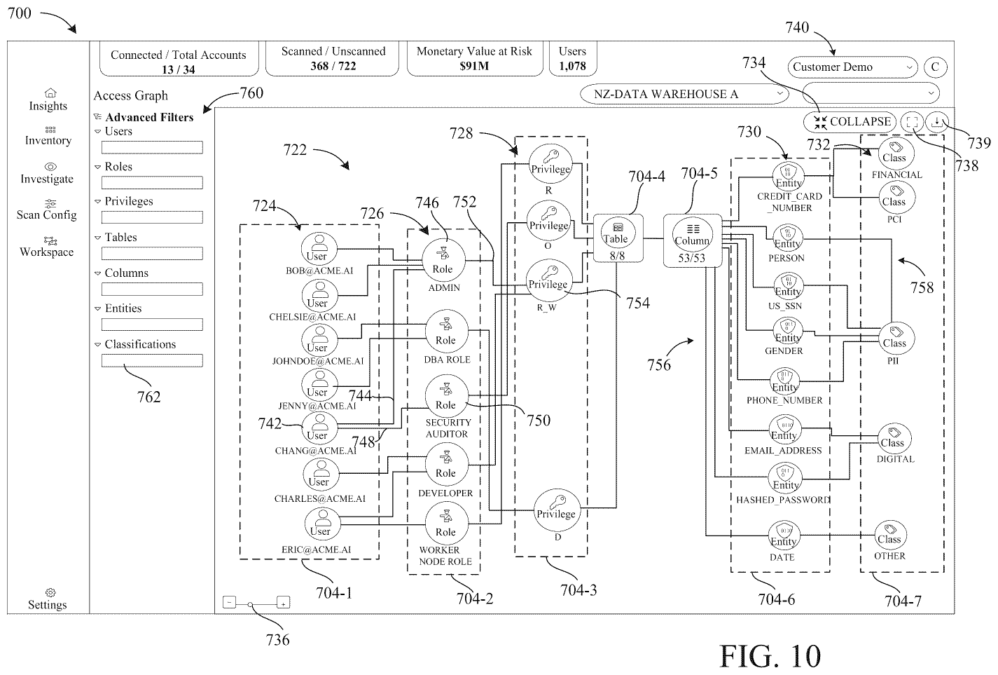

FIG. 10 illustrates graphical interface 700 with an expanded view 722 showing access graph after user actuation of a drill down control, such as control 708 in FIG. 9. In expanded view 722, user group element 704-1 is expanded to include a plurality of individual node elements 724. Similarly, role group element 704-2 is expanded to include a plurality of individual node elements 726, privilege group element 704-3 is expanded to include a plurality of individual node elements 728, entity group element 704-6 is expanded to include a plurality of individual node elements 730, and classification group element 704-7 is expanded to include a plurality of individual node elements 732. Each node element 724 represents one of the users in the user group, each node element 726 represents one of the roles in the role group, each node element 728 represents one of the privileges in the privilege group, each node element 730 represents one of the entities in the entity group, and each node element 732 represents one of the classifications in the classifications group.

In some instances, due to the number of nodes in expanded view 722 and/or a level of zoom applied to the view, only a portion of the graph can be viewable at one time. In this case, window navigation controls, such as slider controls, can be provided to allow a user to navigate through the graph.

A collapsed view control 734 is actuatable to return to, or drill up to, the summary view. Further, a zoom control 736 is configured to receive user input to increase or decrease the zoom level, to change the amount of the access graph that is rendered in the current view in graphical interface 700.

The graphical interface includes a fit to window control 738 and a switch cloud account control 740. Actuation of control 738 causes the current view (summary or expanded view) that is currently displayed in the graphical interface to zoom in or out such that the entire access graph is visible in the current view. The switch cloud account control 740 enables a user to select another cloud account to render the associated access graph in the graphical interface.

Download control 739 downloads the current view, such as by exporting to a particular file type. For instance, a screenshot of the access graph can be captured and stored in an image file. Alternatively, or in addition, a text document can be generated with an enumerated list of the access paths represented on the current view.

In expanded view 722, the edges are also expanded to represent interdependences between the expanded node elements. Descriptive labels can be provided proximate the node elements to identify the constituent elements represented by those node elements. To illustrate, node element 742 includes a label identifying the particular user (chang@acme.ai). A first edge element 744 represents that the particular user has been assigned an administrator role (node element 746) in a first access path and a second edge element 748 represents that the particular user has also been assigned a security auditor role (node element 750) in a second access path. Further, edge element 752 represents that the administrator role has read-write privileges (node element 754) to at least one table represented by node element 704-4.

Edge elements 756 indicate that the columns of the tables include the entities represented by node elements 730, and edge elements 758 indicate that those entities have various data classifications represented by node elements 732.

A filter control 760 is configured to receive one or more of a user criterion, a role criterion, a privilege criterion, a table criterion, a column criterion, an entity criterion, and/or a classification criterion. Based on the inputs through filter control 760, the access graph is filtered to show the access paths that have constituent elements matching the input criteria. For instance, a user selects a desired data classification through a classification input control 762.

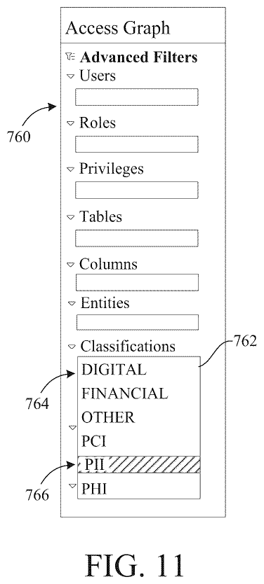

FIG. 11 illustrates one example of classification input control 762. Upon actuation of classification input control 762, a drop down list 764 is provided with a list of the available classifications, for user selection, that have been identified from one or more access paths in the access graph. For example, a user can select personally identifiable information (“PII”) element 766 from the list, and the graphical display (summary view or expanded view) is modified to visually emphasize the access paths that include the selected PII classification. As an example, access paths that do not include the selected PII classification can be removed from the access graph. In another example, all access paths that include the selected PII classification can be visually highlighted, or otherwise identified, in the access graph.

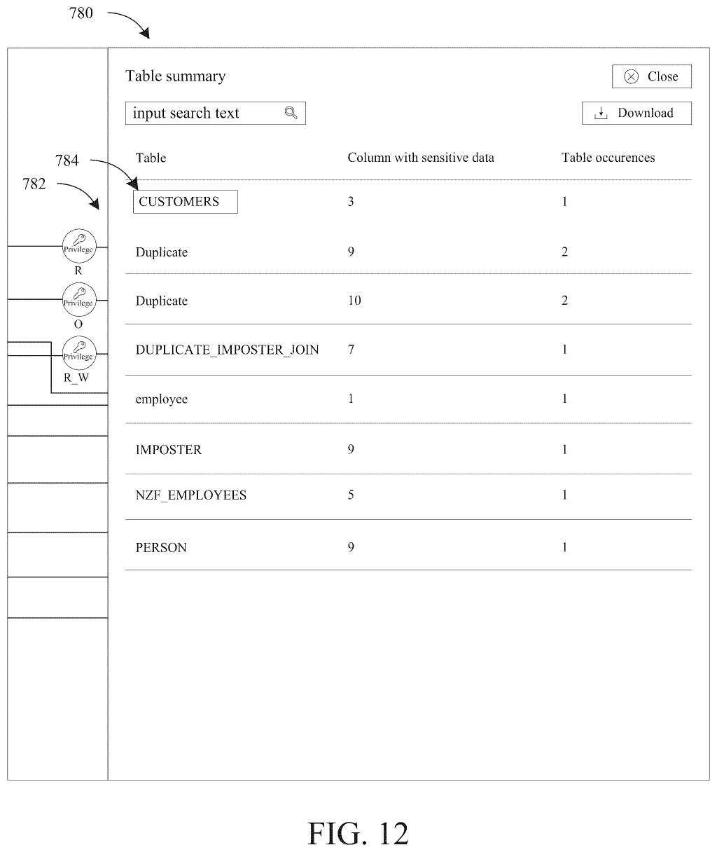

In one example, some or all of the node elements 704 are selectable by a user to display a details pane that provides additional details for the selected node. For example, a user can select table group element 704-4 and, in response, a details pane 780 shown in FIG. 12 is rendered on the graphical interface. Details pane 780 displays details of the eight tables from table group element 704-4, with each table being represented by a row 782 in details pane 780. Each row 782 shows the columns of the table that have sensitive data, and the number of occurrences of the sensitive data.

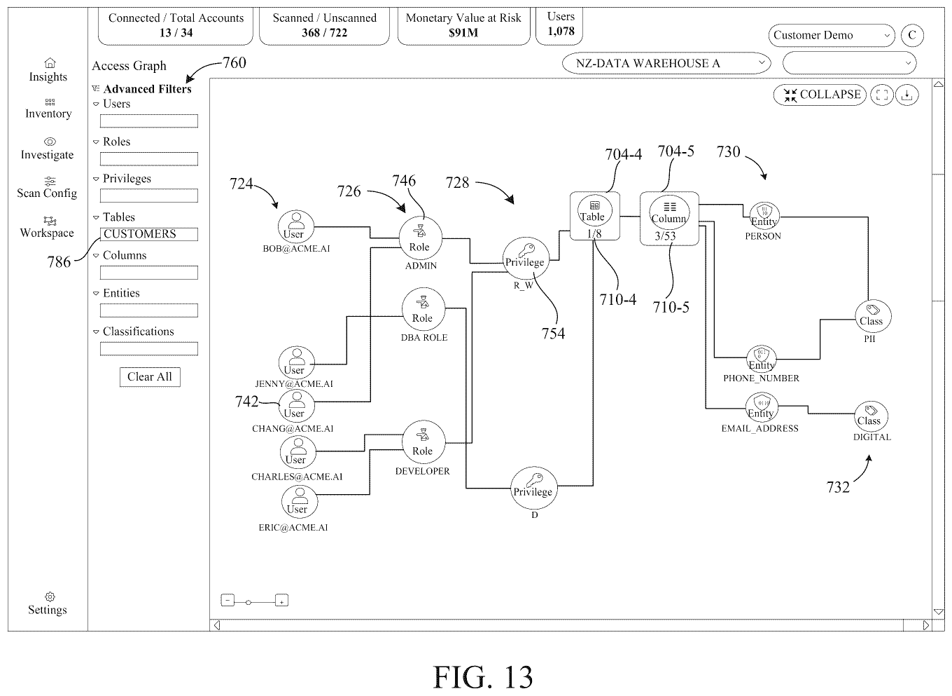

Further, in one example, each row 782 is user selectable to automatically populate the filter control. Illustratively, control 784 representing the “customers” table can be selected by the user to automatically populate the table filter control 786 with “customers” as a filter criterion. In response, as shown in FIG. 13, the unified access graph is automatically updated to filter out any access paths that do not satisfy the filter criterion, that is, any access path that does not include the “customers” table. Accordingly, the numerical counter 710-4 now indicates only one of the eight tables are represented by the table group element 704-4, due to the graph being filtered to only include access paths through the customers table. Similarly, the numerical counter 710-5 of column group element 704-5 is modified to indicate that three of the fifty three columns are represented by column group element 704-5. Further, the node elements 724, 726, 728, 730 and 732 are also filtered to only show the nodes that represent the constituent elements that reside along access paths that include the customer table. For sake of illustration, FIG. 13 shows that five users are assigned three different roles having privileges into the single table (the customers table), and that the single table includes three different entities of two different data classifications.

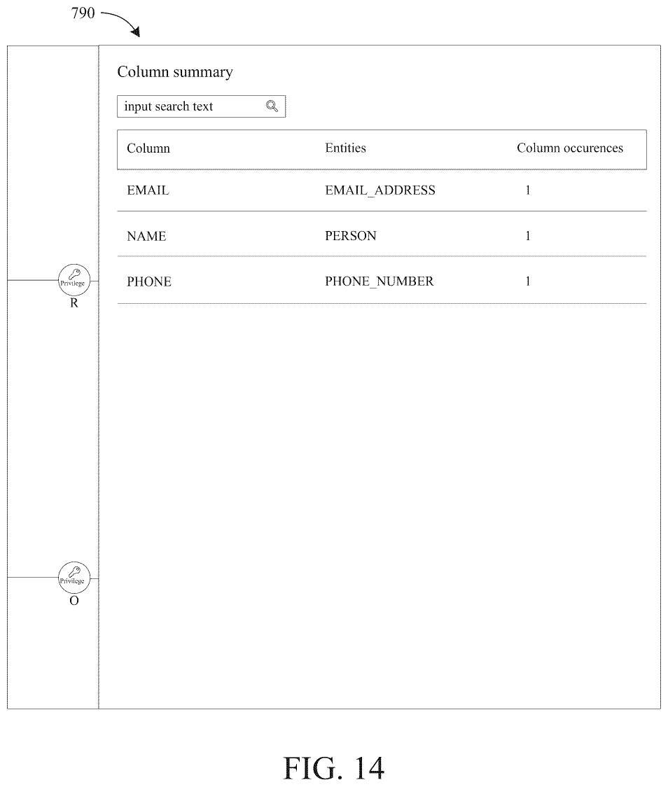

FIG. 14 illustrates a details pane 790 that is displayed in response to user selection of the filtered column group element 704-5 in FIG. 13. Here, details pane 790 shows that there are three columns in the customer table, along with which entities occur in those columns and the number of column occurrences of those entities.

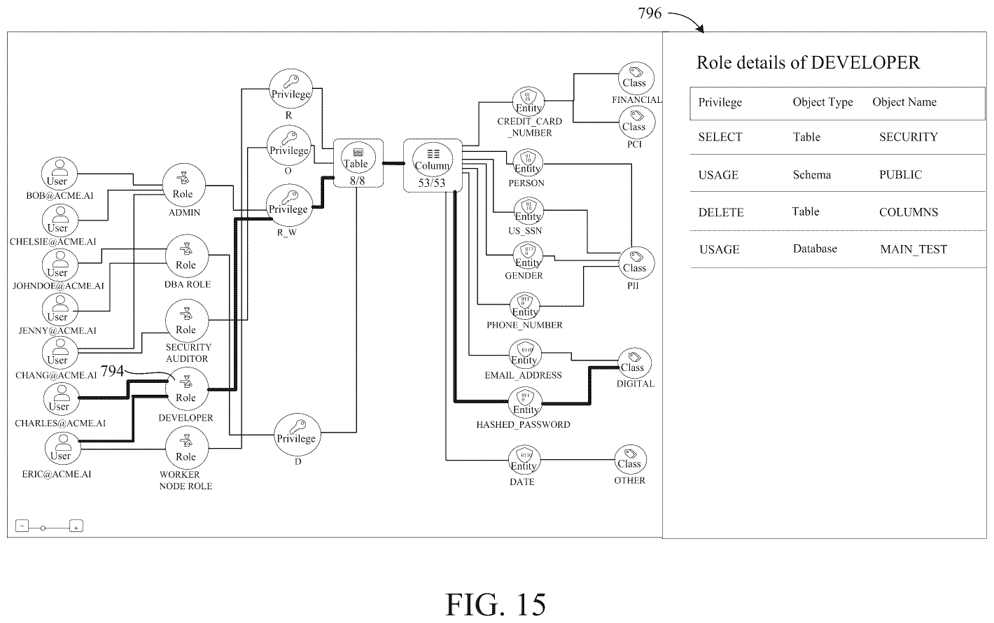

Additionally, from the expanded view, the user can select one or more of the node elements to highlight the connections represented by the edges in the graph, which are connected to the selected node. One example is shown in FIG. 15. Here, when a user selects one or more of the nodes (a user selects node 794 as shown in FIG. 15), the edges that represent the access paths through the selected node are highlighted relative to other edges. Additionally, a details pane 796 is rendered on the interface with details of the selected node. In the present case, role details of the selected developer role are provided to show the privileges that have been assigned to the selected role. This, of course, is for sake of example only and other information can be rendered as well.

It can thus be seen that the present disclosure describes technology for security posture analysis of a cloud account. In some described examples, the technology accesses and analyzes cloud scanner data to discover access paths to cloud resources based on permissions data and access control data. An access graph is constructed to visualize the access path details in an interactive, unified view. In this way, the access graph identifies how user access to particular data stores or other resources are set up, and identifies the type of sensitive data the users have access to. The privileges can be visualized at varying levels of granularity, such as, but not limited to, the data store, database, table and/or column levels. Further, the graph can visually identify interdependencies of users, roles, resources, etc. for remedial action.

One or more implementations of the technology disclosed or elements thereof can be implemented in the form of a computer product, including a non-transitory computer readable storage medium with computer usable program code for performing the method steps indicated. Furthermore, one or more implementations and clauses of the technology disclosed or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

Examples discussed herein include processor(s) and/or server(s). For sake of illustration, but not by limitation, the processors and/or servers include computer processors with associated memory and timing circuitry, and are functional parts of the corresponding systems or devices, and facilitate the functionality of the other components or items in those systems.

As used herein, if a description includes “one or more of” or “at least one of” followed by a list of example features with a conjunction “or” between the penultimate example feature and the last example feature, then this is to be read such that (1) one exemplary embodiment includes at least one of or one or more of each feature of the listed features, (2) another exemplary embodiment includes at least one of or one or more of only one feature of the listed features, and (3) another exemplary embodiment includes some combination of the listed features that is less than all of the features and more than one of the features.

As used herein, if a description includes “one or more of” or “at least one of” followed by a list of example features with a conjunction “and” between the penultimate example feature and the last example feature, then this is to be read such that the exemplary embodiment includes at least one of or one or more of each feature of all the listed features.

As used herein, if a description includes “one or more of” or “at least one of” followed by a list of example features with a conjunction “and/or” between the penultimate example feature and the least example feature, then this is to be read such that, in one example, the description includes “one or more of” or “at least one of” followed by a list of example features with a conjunction “or” between the penultimate example feature and the last example feature, and, in another example, the description includes “one or more of” or “at least one of” followed by a list of example features with a conjunction “and” between the penultimate example feature and the last example feature.

Also, user interface displays have been discussed. Examples of user interface displays can take a wide variety of forms with different user actuatable input mechanisms. For instance, a user input mechanism can include icons, links, menus, text boxes, check boxes, etc., and can be actuated in a wide variety of different ways. Examples of input devices for actuating the input mechanisms include, but are not limited to, hardware devices (point and click devices, hardware buttons, switches, a joystick or keyboard, thumb switches or thumb pads, etc.) and virtual devices such as virtual keyboards or other virtual actuators. For instance, a user actuatable input mechanism can be actuated using a touch gesture on a touch sensitive screen. In another example, a user actuatable input mechanism can be actuated using a speech command.

The present figures show a number of blocks with corresponding functionality described herein. It is noted that fewer blocks can be used, such that functionality is performed by fewer components. Also, more blocks can be used with the functionality distributed among more components. Further, the data stores discussed herein can be broken into multiple data stores. All of the data stores can be local to the systems accessing the data stores, all of the data stores can be remote, or some data stores can be local while others can be remote.

The above discussion has described a variety of different systems, components, logic, and interactions. One or more of these systems, components, logic and/or interactions can be implemented by hardware, such as processors, memory, or other processing components. Some particular examples include, but are not limited to, artificial intelligence components, such as neural networks, that perform the functions associated with those systems, components, logic, and/or interactions. In addition, the systems, components, logic and/or interactions can be implemented by software that is loaded into a memory and is executed by a processor, server, or other computing component, as described below. The systems, components, logic and/or interactions can also be implemented by different combinations of hardware, software, firmware, etc., some examples of which are described below. These are some examples of different structures that can be used to implement any or all of the systems, components, logic, and/or interactions described above.

The elements of the described figures, or portions of the elements, can be disposed on a wide variety of different devices. Some of those devices include servers, desktop computers, laptop computers, tablet computers, or other mobile devices, such as palm top computers, cell phones, smart phones, multimedia players, personal digital assistants, etc.

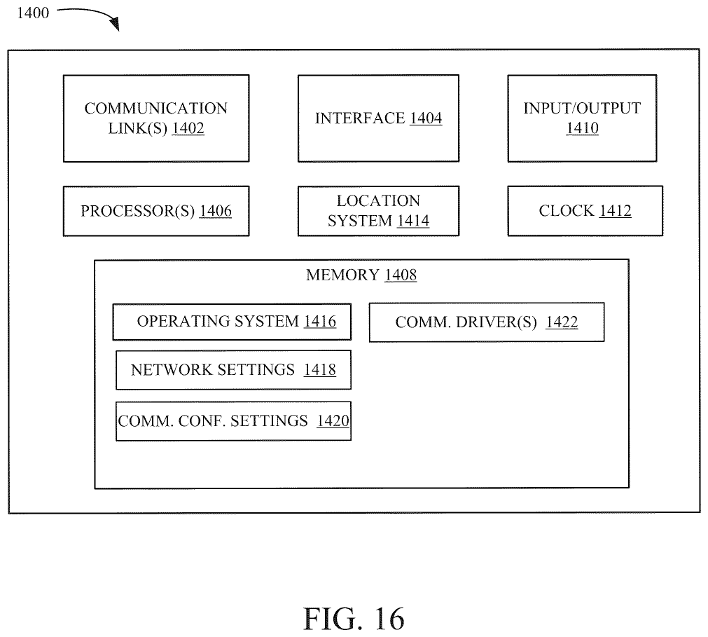

FIG. 16 is a simplified block diagram of one example of a client device 1400, such as a handheld or mobile device, in which the present system (or parts of the present system) can be deployed.

One or more communication links 1402 allows device 1400 to communicate with other computing devices, and can provide a channel for receiving information automatically, such as by scanning. An example includes communication protocols, such as wireless services used to provide cellular access to a network, as well as protocols that provide local wireless connections to networks.

Applications or other data can be received on an external and/or removable storage device or memory that is connected to an interface 1404. Interface 1404 and communication links 1402 communicate with one or more processors 1406 (which can include processors or servers described with respect to the figures) along a communication bus (not shown in FIG. 24), that can also be connected to memory 1408 and input/output (I/O) components 1410, as well as clock 1412 and a location system 1414.

Components 1410 facilitate input and output operations for device 1400, and can include input components such as microphones, touch screens, buttons, touch sensors, optical sensors, proximity sensors, orientation sensors, accelerometers. Components 1410 can include output components such as a display device, a speaker, and or a printer port.

Clock 1412 includes, in one example, a real time clock component that outputs a time and date, and can provide timing functions for processor 1406. Location system 1414 outputs a current geographic location of device 1400 and can include a global positioning system (GPS) receiver, a LORAN system, a dead reckoning system, a cellular triangulation system, or other positioning system. Memory 1408 stores an operating system 1416, network applications and corresponding configuration settings 1418, communication configuration settings 1420, communication drivers 1422, and can include other items. Examples of memory 1408 include types of tangible volatile and non-volatile computer-readable memory devices. Memory 1408 can also include computer storage media that stores computer readable instructions that, when executed by processor 1406, cause the processor to perform computer-implemented steps or functions according to the instructions. Processor 1406 can be activated by other components to facilitate functionality of those components as well.

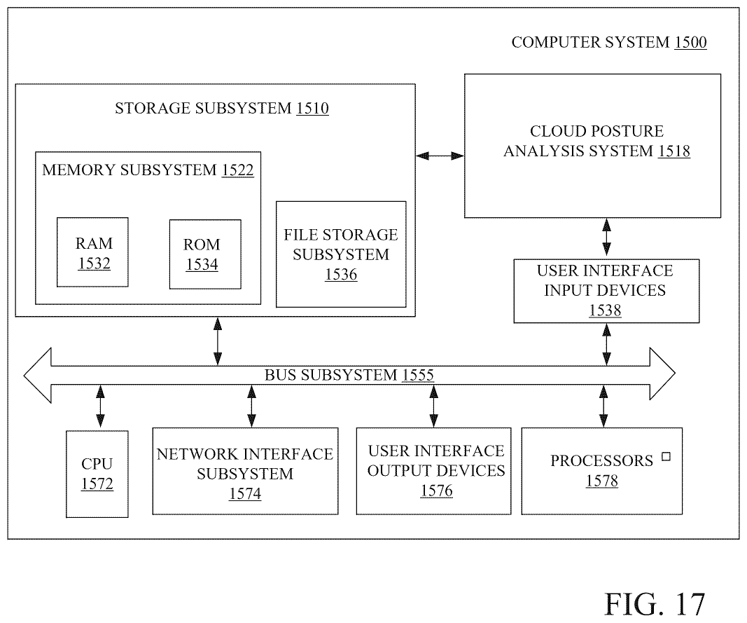

FIG. 17 shows an example computer system 1500 that can be used to implement the technology disclosed. Computer system 1500 includes at least one central processing unit (CPU) 1572 that communicates with a number of peripheral devices via bus subsystem 1555. These peripheral devices can include a storage subsystem 1510 including, for example, memory devices and a file storage subsystem 1536, user interface input devices 1538, user interface output devices 1576, and a network interface subsystem 1574. The input and output devices allow user interaction with computer system 1500. Network interface subsystem 1574 provides an interface to outside networks, including an interface to corresponding interface devices in other computer systems.

In one implementation, cloud data/security posture analysis system 1518 is communicably linked to the storage subsystem 1510 and the user interface input devices 1538.

User interface input devices 1538 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1500.

User interface output devices 1576 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1500 to the user or to another machine or computer system.

Storage subsystem 1510 stores programming and data constructs that provide the functionality of some or all of the modules and methods described herein. These software modules are generally executed by processors 1578.

Processors 1578 can be graphics processing units (GPUs), field-programmable gate arrays (FPGAs), application-specific integrated circuits (ASICs), and/or coarse-grained reconfigurable architectures (CGRAs). Processors 1578 can be hosted by a deep learning cloud platform such as Google Cloud Platform™, Xilinx™, and Cirrascale™.

Memory subsystem 1522 used in the storage subsystem 1510 can include a number of memories including a main random access memory (RAM) 1532 for storage of instructions and data during program execution and a read only memory (ROM) 1534 in which fixed instructions are stored. A file storage subsystem 1536 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1536 in the storage subsystem 1510, or in other machines accessible by the processor.

Bus subsystem 1555 provides a mechanism for letting the various components and subsystems of computer system 1500 communicate with each other as intended. Although bus subsystem 1555 is shown schematically as a single bus, alternative implementations of the bus subsystem can use multiple busses.

Computer system 1500 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 1500 depicted in FIG. 17 is intended only as a specific example for purposes of illustrating the preferred implementations of the present invention. Many other configurations of computer system 1500 are possible having more or less components than the computer system depicted in FIG. 17.

It should also be noted that the different examples described herein can be combined in different ways. That is, parts of one or more examples can be combined with parts of one or more other examples. All of this is contemplated herein.

The technology disclosed can be practiced as a system, method, or article of manufacture. One or more features of an implementation can be combined with the base implementation. Implementations that are not mutually exclusive are taught to be combinable.

One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for detection and organization of access paths in a computing environment, the system comprising:
a processor; and
memory accessible by the processor, the memory including instructions executable to:
access permissions data and access control data for one or more computing resources in the computing environment;
assemble a set of access paths to the one or more computing resources based on the permissions data and the access control data;
trace the set of access paths to enumerate constituent elements along the access paths to the one or more computing resources; and
automatically construct a unified access path graph representing the set of access paths, the unified access path graph comprising node display elements connected by edge display elements to represent interdependencies between the constituent elements at one or more levels of granularity along the access paths to the one or more computing resources.

2. The system of claim 1, wherein the constituent elements comprise users, roles, and access privileges to one or more data stores in the one or more computing resources.

3. The system of claim 2, wherein the node display elements comprise:
a user group element representing a user group of one or more users;
a role group element representing a role group of one or more roles associated with the one or more users;
a privilege group element representing a privilege group of one or more privileges associated with the one or more roles; and
a data store group element representing a data store group of the one or more data stores associated with the one or more privileges.

4. The system of claim 3, wherein the one or more data stores comprise one or more structured data stores, and the data store group element comprises one or more of:
a table group element representing a table group of data tables in the one or more structured data stores, or
a column group element representing a data column group of data columns in the one or more structured data stores.

5. The system of claim 4, wherein the unified access path graph includes a numerical counter identifying a number of constituent elements in at least one of the user group, the role group, the privilege group element, or the data store group.

6. The system of claim 4, wherein the one or more data stores comprise one or more structured data stores, and the node display elements comprises:
an entity group element representing instances of data stored in the one or more structured data stores matching one or more predefined data entity profiles; and
a classification group element representing classification tags associated with the instances of data matching the one or more predefined data entity profiles.

7. The system of claim 1, wherein one or more of the node display elements includes an available drill down to select the one or more levels of granularity.

8. The system of claim 7, wherein the memory including instructions executable to:
receive a selection of the available drill down and, in response, modify a visualization of the unified access path graph to include an expanded view of the set of user access paths.

9. The system of claim 8, wherein the expanded view comprises one or more of:
a plurality of user node display elements, each user node display element, of the plurality of user node display elements, representing a respective user of a plurality of users;
a plurality of role node display elements, each role node display element, of the plurality of role node display elements, representing a respective role of a plurality of roles;
a plurality of user/role edge display elements, each user/role edge display element, of the plurality of user/role edge display elements, representing a connection between a respective user/role pair;
a plurality of privilege node display elements, each privilege node display element, of the plurality of privilege node display elements, representing a respective privilege of a plurality of privileges;
a plurality of role/privilege edge display elements, each role/privilege edge display element, of the plurality of role/privilege edge display elements, representing a connection between a respective role/privilege pair;
a plurality of data store node display elements, each data store node display element, of the plurality of data store node display elements, representing a respective data store of a plurality of data stores; or
a plurality of privilege/data store edge display elements, each privilege/data store edge display element, of the plurality of privilege/data store edge display elements, representing a connection between a respective privilege/data store pair.

10. The system of claim 1, wherein the unified access path graph includes a filter control that is actuatable to filter the node display elements based on a filter criterion.

11. The system of claim 10, wherein the filter criterion comprises at least one of:
a user criterion;
a role criterion;
a privilege criterion;
a table criterion;
a column criterion;
an entity criterion; or
a classification criterion.

12. The system of claim 1, wherein the unified access path graph is configured to consolidate access paths to a multiplicity of data store types.

13. The system of claim 1, wherein the computing environment is configured to integrate with an external resource, that is external to the computing environment, and manages access of internal users of the computing environment, and wherein the set of access paths includes one or more access paths of the internal users of the computing environment and one or more access paths of external users of the external resource.

14. The system of claim 1, wherein the unified access path graph represents data sensitivity classifications along the set of access paths.

15. A computer-implemented method for detecting and presenting data access paths in a computing environment, the computer-implemented method comprising:
accessing permissions data and access control data for one or more computing resources in the computing environment;
analyzing the permissions data and access control data to identify a set of access paths that define users, roles, and access privileges to one or more data stores in the one or more computing resources; and
generating a graphical representation of the set of user access paths, the graphical representation comprising a plurality of node display elements connected by edge display elements, wherein the plurality of node display elements includes:
a user group element representing one or more users;
a role group element representing one or more roles associated with the one or more users;
a privilege group element representing one or more privileges associated with the one or more roles; and
a data store group element representing the one or more data stores associated with the one or more privileges.

16. The computer-implemented method of claim 15, wherein one or more of the plurality of node display elements includes an available drill down into constituent elements of access paths in the graphical representation.

17. The computer-implemented method of claim 16, and further comprising receiving a selection of the available drill down and, in response, modify a visualization of the graphical representation to include an expanded view of the set of user access paths.

18. A method for detecting access paths in a computing environment, the method comprising:
clustering network access path data into constituent element groups representing access paths to one or more resources in the computing environment; and
generating a graphic of cascading interdependencies among the constituent element groups in the access paths with available drill down into individual access path constituents of one or more of the constituent element groups.

19. The method of claim 18, wherein the constituent element groups comprise users, roles, and access privileges to the one or more computing resources.

20. The method of claim 18, and further comprising:
receiving a selection of the available drill down and, in response, modifying the graphic to include an expanded view of the access paths.
